(19) United States
(12) Patent Application Publication
(10) Pub. No.: US 2007/0040976 A1
(43) Pub. Date: Feb. 22, 2007

(54) Liquid crystal display and method of manufacturing the same

(75) Inventors: Dong-ki Lee, Yongin-si (KR); Jae-sung Kim, Yongin-si (KR); Hi-kuk Lee, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/506,295

(22) Filed: Aug. 18, 2006

(30) Foreign Application Priority Data
Aug. 17, 2005 (KR) 10-2005-0075036

(51) Int. Cl. G02F 1/141; G02F 1/1339

(52) U.S. Cl. 349/134; 349/155

(57) ABSTRACT

A liquid crystal display (LCD) and a method of manufacturing the same. The LCD includes a first display panel including a first field-generating electrode formed on a first insulating substrate, a second display panel opposite to the first display panel and including a second field-generating electrode formed on a second insulating substrate, a liquid crystal layer formed between the first display panel and the second display panel, and organic layers formed on the second field-generating electrode and including a cell gap maintaining unit positioned between the first display panel and the second display panel, for allowing the first display panel and the second display panel to maintain a constant gap therebetween, and a liquid crystal alignment guide unit having a tilt surface that pre-tilts the liquid crystal layer, the liquid crystal alignment guide unit and the cell gap maintaining unit having a top height difference of not less than 2 μm.

### REFERENCE TO RELATED APPLICATION

This application claims priority from Korean Patent Application No. 10-2005-0075306 filed on Aug. 17, 2005 in the Korean Intellectual Property Office, the disclosure of which is incorporated herein by reference in its entirety.

### BACKGROUND OF THE INVENTION

1. Field of the Invention

The present invention relates to a liquid crystal display (LCD), and more particularly, to an LCD in which a space for interposing a liquid crystal layer between a first display panel and a second display panel can be secured in a vertically aligned mode LCD, and a method for manufacturing the LCD.

2. Description of the Related Art

Liquid crystal displays (LCDs), capable of displaying information using electrical and optical properties of liquid crystals injected into a liquid crystal panel, have some notable advantages, such as low power consumption and low driving voltages, light weight and small size compared to CRTs. Due to such advantages, LCDs are being actively researched and developed. Recently, LCDs are used in a wide variety of applications such as, portable computers, desktop computer monitors, monitors of high-quality image display devices, or the like.

LCDs are largely classified into a In-Plane Switching (IPS) type and a Vertical Alignment (VA) type depending upon the direction of the electric field driving the liquid crystal. The VA type LCD is constructed such that when a voltage is applied, liquid crystal molecules are controlled to be aligned vertically to adjust transmittance of light and such that the long axes of the liquid crystal molecules are perpendicular to the substrates in the absence of an electric field. The VA type gives high contrast ratio and affords a wide viewing angle.

In particular, the wide viewing angle of the VA mode LCD can be realized by providing cutouts and protrusions in the field-generating electrodes. Since the cutouts and the protrusions can determine the tilt directions of the LC molecules, the tilt directions can be distributed in several directions such that the reference viewing angle is widened.

Here, the control of the movement direction of liquid crystal molecules using the cutout is effective in an area adjacent to the cutout, but its effect is small with respect to liquid crystal molecules away from the cutouts. As a result, such liquid crystal molecules are not tilted in a desired direction and a texture may be generated. To address this problem, a pre-tilted organic layer is interposed between a pixel electrode and an alignment layer and/or between a common electrode and the alignment layer to pre-tilt liquid crystal molecules of the alignment layer. The pre-tilted organic layer is formed using a slit mask. In order to reduce the number of masks required for formation of the organic layer, a cell gap maintaining unit is necessarily provided between a first display panel and a second display panel.

However, when both the cell gap maintaining unit and the organic layer are formed using a single slit mask, like in a conventional method, it is quite difficult to obtain a predetermined height profile between the cell gap maintaining unit and the organic layer. In other words, it is not easy to obtain an increased space enough to interpose a liquid crystal layer between the first display panel and the second display panel.

### SUMMARY OF THE INVENTION

The present invention provides a liquid crystal display and a method of manufacturing the same in which the LCD has an increased space between a first display panel and a second display panel for interposing a liquid crystal layer therebetween.

According to an aspect of the present invention, a first field-generating electrode is formed on a first insulating substrate and a second field-generating electrode is formed on a second insulating substrate. Organic layers are formed on the second field-generating electrode including a cell gap maintaining unit positioned between the first display panel and the second display panel to maintain a constant gap therebetween. A liquid crystal alignment guide unit has a tilt surface that pre-tilts the liquid crystal layer, the liquid crystal alignment guide unit and the cell gap maintaining unit having a top height difference of not less than 2 μm. According to another aspect of the present invention, the method of manufacturing the liquid crystal display includes forming a first display panel including a first field-generating electrode on a first insulating substrate, forming a second field-generating electrode on a second insulating substrate, forming organic layers including a cell gap maintaining unit positioned between the first display panel and the second display panel and a liquid crystal alignment guide unit having a tilt surface and having a top height difference of not less than 2 μm between the liquid crystal alignment guide unit and the cell gap maintaining unit on the second field-generating electrode.

### BRIEF DESCRIPTION OF THE DRAWINGS

The above and other features and advantages of the present invention will become more apparent by describing in detail exemplary embodiments thereof with reference to the attached drawings in which:

FIG. 1A is a layout view of a first display panel in a liquid crystal display (LCD) according to an embodiment of the present invention;

FIG. 1B is a layout view of a second display panel in the LCD according to an embodiment of the present invention;

FIG. 1C is a layout view of the LCD including the first display panel of FIG. 1A and the second display panel of FIG. 1B;

FIG. 2 is a sectional view taken along a line II-II′ of FIG. 1C;

FIGS. 3A through 3E are sectional views taken along a line II-II′ of FIG. 1C for showing a process of manufacturing a first display panel according to an embodiment of the present invention;

FIGS. 4A through 41 are sectional views taken along a line II-II′ of FIG. 1C for showing a process of manufacturing a second display panel according to an embodiment of the present invention;

FIG. 5A is a layout view of a first display panel in an LCD according to another embodiment of the present invention;

FIG. 5B is a layout view of a second display panel in the LCD according to another embodiment of the present invention;

FIG. 5C is a layout view of the LCD including the first display panel of FIG. 5A and the second display panel of FIG. 5B; and

FIG. 6 is a sectional view taken along a line VI-VI′ of FIG. 5C.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown.

Examples of a liquid crystal display used in the present invention may include, but not limited to, portable multimedia players (PMP), personal digital assistants (PDA), portable digital versatile disk (DVD) players, cellular phones, notebooks, and digital TVs.

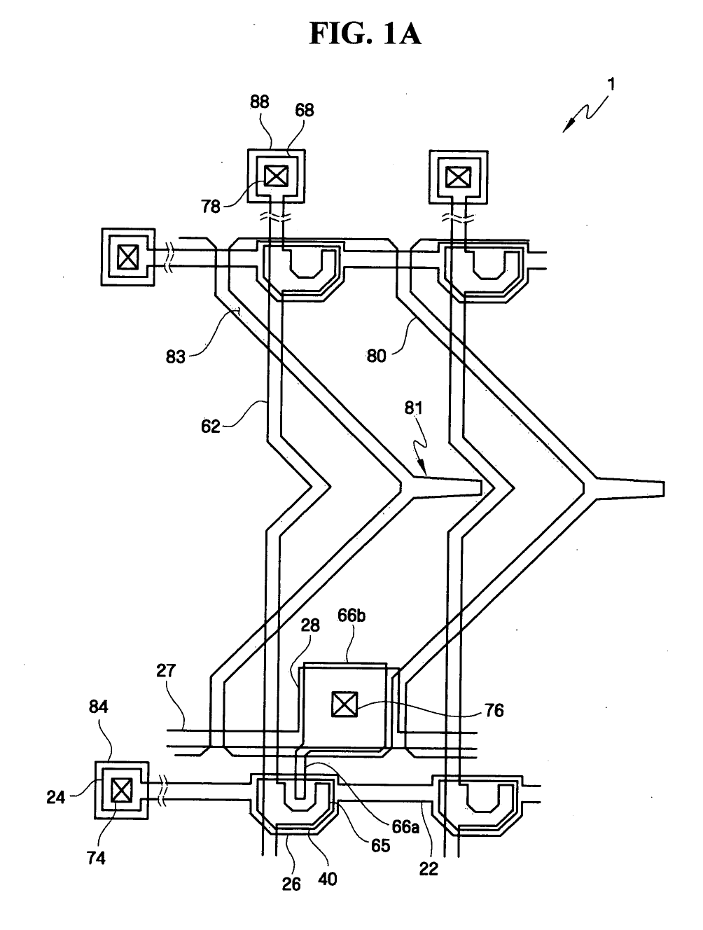

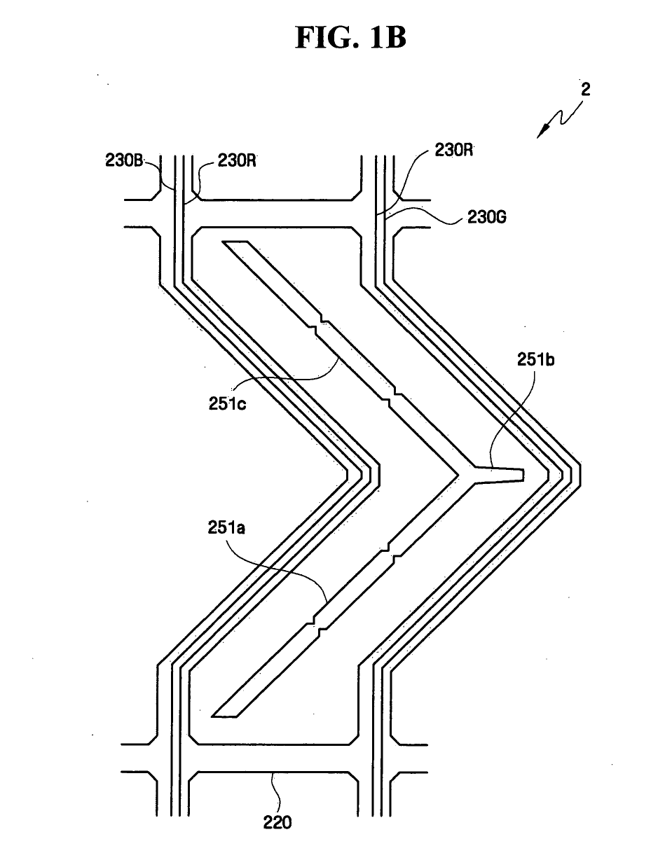

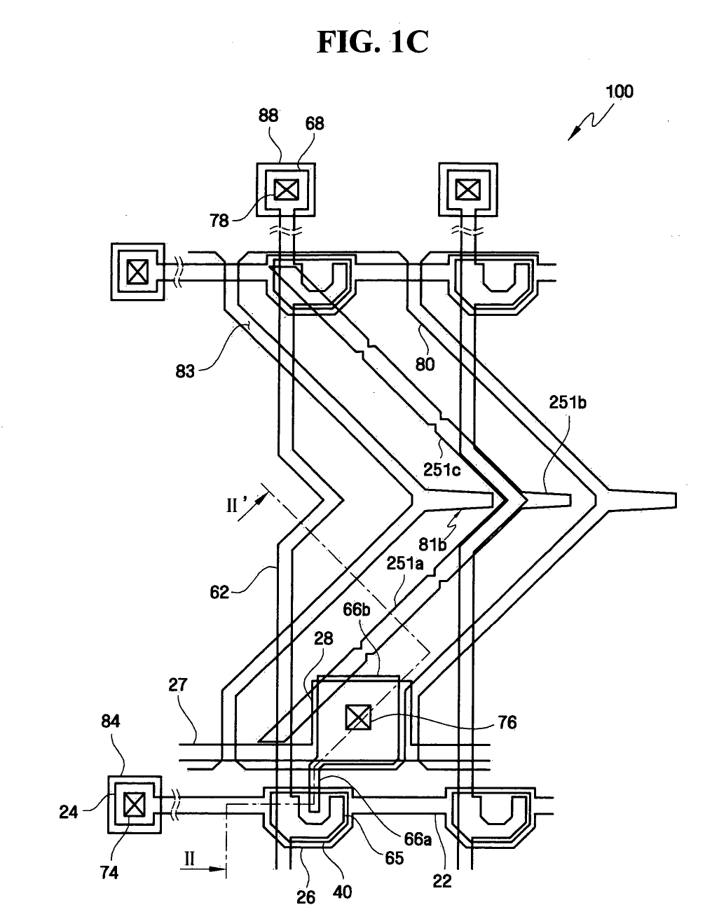

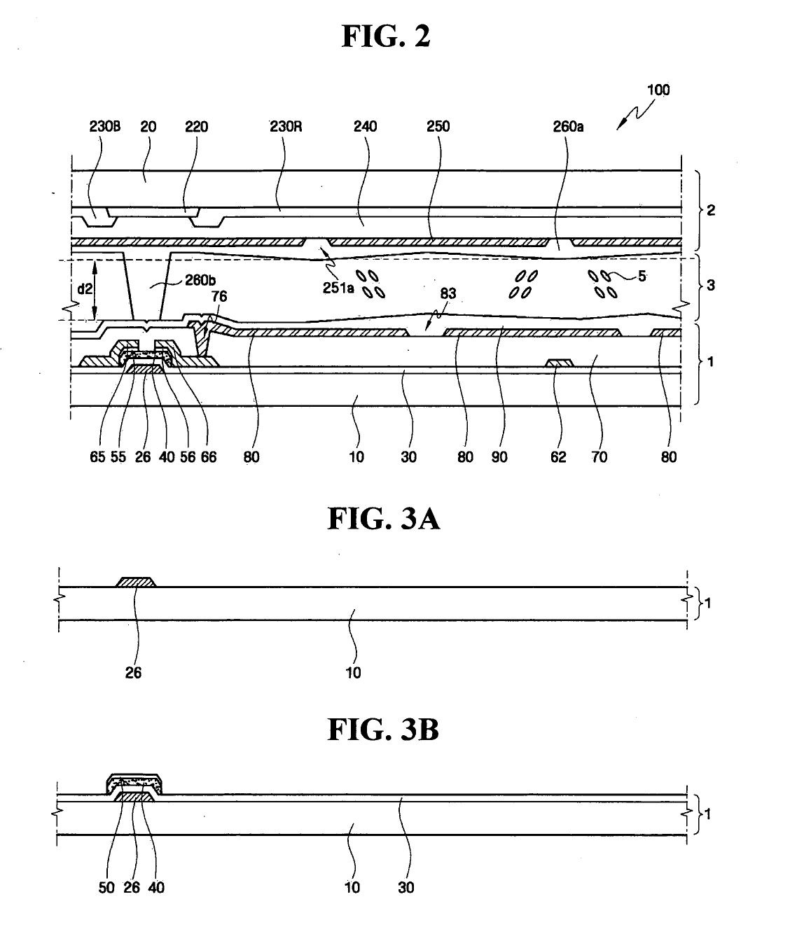

Referring to FIG. 1A, FIG. B, FIG. 1C and FIG. 2, LCD 100 includes a first display panel 1 (FIG. 1A), a second display panel 2 (FIG. 1B) opposite to the first display panel 1, and a liquid crystal layer 3 (FIG. 2) including liquid crystal molecules 5 injected between the first display panel 1 and the second display panel 2 and aligned perpendicularly to the first display panel 1 and the second display panel 2.

The first display panel 1 includes a gate line 22 extending in a transverse direction on an insulating substrate 10 (FIG. 2). A protruding gate electrode 26 is formed on the gate line 22. A gate pad 24 is formed at an end of the gate line 22 to receive a gate signal from other layers or an external circuit and transmit the received gate signal to the gate line 22. The gate pad 24 has a width that is expanded to be connected to an external circuit. The gate line 22, the gate electrode 26, and the gate pad 24 constitute a gate wire (22, 26, 24).

In addition, a storage electrode line 27 and a storage electrode 28 are formed on the insulating substrate 10. The storage electrode line 27 extends in a transverse direction across a pixel region and the storage electrode 28 is connected to the storage electrode line 27 that is wider than the storage electrode line 28. The storage electrode line 27 and the storage electrode 28 constitute a storage electrode wire (27, 28). The shapes and arrangements of the storage electrode wire (27, 28) may vary in various manners.

The gate wire (22, 26, 24) and the storage electrode wire (27, 28) may be made of an aluminum (Al) based metal such as aluminum or an aluminum alloy, a silver-based metal such as silver (Ag) or a silver alloy, a copper-based metal such as copper (Cu) or copper alloy, a molybdenum-based metal such as molybdenum (Mo) or molybdenum alloy, chromium (Cr), titanium (Ti), tantalum (Ta), or the like. In addition, the gate wire (22, 26, 24) and the storage electrode wire (27, 28) may have a multi-layered structure including two different conductive films (not shown) having different physical properties. In this case, one of the conductive films is preferably made of a low resistivity metal such as Al, Ag, Cu, or alloys thereof for reducing signal delay or a voltage drop, and the other film is preferably made of a material having a superior contact characteristic with respect to ITO and IZO, such as a Mo based metal, Cr, Ti, Ta, or the like. Good examples of the combination of the two films are a lower Cr layer and an upper Al layer, a lower Al layer and an upper Cr layer, and so on.

A gate insulating layer 30 is formed on the gate wire (22, 24, 26) and the storage electrode wire (27, 28).

Referring to FIG. 2, a semiconductor layer 40 made of hydrogenated amorphous silicon or polycrystalline silicon is formed on the gate insulating layer 30. The semiconductor layer 40 may have various shapes such as island shapes or stripe shapes. In the illustrative embodiment, for example, the semiconductor layer 40 may be formed in an island shape. When the semiconductor layer 40 is formed in a stripe shape, it may be disposed under the data line 62 and extend over the gate electrode 26.

An island-shaped or stripe-shaped ohmic contact layer made of silicide or n+hydrogenated amorphous silicon doped with high-concentration n-type impurity may be formed on the semiconductor layer 40. In the illustrative embodiment, for example, ohmic contact layers 55 and 56 are in an island shape and are positioned under a source electrode 65 and drain electrodes 66a and 66b, respectively. A stripe-shaped ohmic contact layer may extend under the data line 62. The data line 62 and the drain electrodes 66a and 66b are formed on the ohmic contact layers 55 and 56 and the gate insulating layer 30.

The data line 62 (FIG. 1A) extends in a longitudinal direction and intersects the gate line 22 to define a pixel. The source electrode 65 extends over the ohmic contact layer 55 as a branch of the data line 62. A data pad 68 is formed at an end of the data line 62 to receive a data signal from other layers or external circuit and transmit the received data signal to the data line 62. The width of the data pad 68 is expanded to be connected to an external circuit. The drain electrodes 66a and 66b are separated from the source electrode 65 and are positioned on the ohmic contact layer 56 opposite to the source electrode 65 in view of the gate electrode 26. The data line 62, the data pad 68, and the source electrode 65 constitute a data wire (62, 68, 65).

Here, the data line 62 includes repeatedly bent portions and longitudinal portions. The bent portions of the data line 62 include a pair of lines one forming an angle of about 45 degrees with respect to the gate line 22 and the other forming an angle of about −45 degrees with the gate line 22. Each of the longitudinal portions is connected to the source electrode 65 and intersects the gate line 22 and the storage electrode line 27. The length of the bent portions is about one to nine times the length of the longitudinal portions. That is, it preferably occupies about 50-90% of the total length of the bent portion and the longitudinal portions.

Thus, pixel areas defined by crossing of the gate line 22 and the data line 62 appear to have a bent band shape. As such, the data line 62 may be formed by a combination of longitudinal and bent band shapes like a pixel shape. However, the invention is not limited to the illustrated example, and the data line 62 may be formed in simply linear or bent band shapes.

The drain electrodes 66a and 66b overlap with the storage electrode 28 with the gate insulating layer 30 interposed therebetween, thereby forming a storage capacitor.

The data line 62, the source electrode 65 and the drain electrodes 66a and 66b are preferably made of a refractory metal such as Cr, a metal containing Mo, Ta, or Ti. Also, the data line 62, the source electrode 65 and the drain electrodes 66a and 66b may have a multi-layered structure including a lower refractory metal film and a low-resistivity upper film (not shown). Examples of the multi-layered structure include a double-layered structure having an upper Cr film and an upper Al film or a lower Al film and an upper Mo film, and a triple-layered structure having a lower Mo film, an intermediate Al film, and an upper Mo film.

The source electrode 65 overlaps with at least a portion of the semiconductor layer 40. The drain electrodes 66a and 66b are opposite to the source electrode 65 with respect to the gate electrode 26 and overlap with at least a portion of the semiconductor layer 40. The ohmic contact layers 55 and 56 are interposed between the underlying semiconductor layer 40 and the overlying source electrode 65 and the drain electrodes 66a and 66b to reduce a contact resistance.

A passivation layer 70 (FIG. 2) made of an organic insulating layer is formed on the data line 62, the drain electrodes 66a and 66b, and an exposed portion of the semiconductor layer 40. Passivation layer 70 is preferably made of an inorganic insulator such as silicon nitride or silicon oxide, a photosensitive organic material having a good flatness characteristic, or a low dielectric insulating material such as a-Si:C:O and a-Si:O:F formed by plasma enhanced chemical vapor deposition (PECVD). In addition, passivation layer 70 may be formed as a double layer consisting of a lower inorganic layer and an upper organic layer so as to provide superior organic layer characteristics and effectively protect the exposed portions of semiconductor layer 40.

Contact holes 78 and 76 respectively exposing data pad 68 and drain electrodes 66a and 66b are formed in passivation layer 70. A contact hole 74 exposing gate pad 24 is formed in passivation layer 70 and gate insulating layer 30. A bent-band shaped pixel electrode 80 electrically connected to drain electrodes 66a and 66b through contact hole 76 and positioned at each pixel is formed on passivation layer 70.

An auxiliary gate pad 84 connected to gate pad 24 and an auxiliary data pad 88 connected to data pad 68 are formed on passivation layer 70 through contact holes 74 and 78, respectively. Here, pixel electrode 80 and auxiliary gate and data pads 84 and 88 are made of a transparent conductor such as ITO or a reflective conductor such as Al. auxiliary gate pad 84 and auxiliary data pad 88 complement the adhesion between gate pad 24 and data pad 68 and an external device.

Pixel electrode 80 is physically and electrically connected to drain electrodes 66a and 66b through contact hole 76 and receives a data voltage from drain electrodes 66a and 66b.

Pixel electrode 80, to which the data voltage is supplied, generates an electrical field together with common electrode 240 of the common electrode substrate 2, to determine arrangement of liquid crystal molecules 5 of liquid crystal layer 3 between pixel electrodes 80 and common electrode 240.

A cutout 81 is formed in the center of pixel electrode 80 in a direction parallel to gate line 22. Although not shown in the illustrative embodiment of the present invention, at least one cutout (not shown) may be formed in pixel electrode 80 in parallel with data line 62 and pixel electrode 80 may be divided into a plurality of domains by the cutout (not shown). The cutout is called domain division means that can divide not only pixel electrode 80 but also common electrode 240 of common electrode display panel 2 into a plurality of domains. The arrangement of liquid crystal molecules 5 of liquid crystal layer 3 can be determined using a fringe field generated by the domain division means.

An organic layer 90 having a tilted surface, which pre-tilts liquid crystal molecules 5, is formed on pixel electrode 80. Organic layer 90 is relatively thick at a portion of a pixel gap 83 and gradually thinner toward the center of pixel electrode 80 from pixel gap 83. In other words, a region corresponding to pixel gap 83 becomes an organic layer ridge that is relatively higher than other parts. At this time, it is preferable that the organic layer ridge has an angle larger than a critical value to prevent an afterimage from being generated.

Photoresist used to form the organic layer 90 includes a solvent for controlling viscosity, a PAC (Photo-active compound), etc., and a chemical binder resin. The photoresist may be a positive type Novolak-based resin having an exposed region dissolved in a developing solution or a negative type acryl-based resin having a non-exposed region dissolved in a developing solution. In the illustrative embodiment of the present invention, the positive type photoresist is used.

Although not shown, an alignment layer for aligning liquid crystal molecules 5 is formed on organic layer 90 having a tilted surface, which pre-tilts liquid crystal molecules 5. The alignment layer is conformal to organic layer 90 to then be pre-tilted. Thus, liquid crystal molecules 5 can be laid down under the influence of the fringe field by pixel gap 83 and cutout 81, the alignment guiding force induced by the pre-tilted alignment layer, and a change in the equi-potential line due to a difference in the cell gap caused by the different thicknesses of organic layer 90 according to the locations. When an electric field is applied to the common electrode and pixel electrode 80, even the direction in which liquid crystal molecules 5 that are not adjacent to cutout 81 are laid down can be determined. Thus, the overall motion of liquid crystal molecules 5 is promoted, thereby attaining a quick response speed. If organic layer 90 is capable of aligning liquid crystals, a separate alignment layer may not be necessarily formed.

With reference to the second display panel 2, a black matrix 220 for preventing light leakage is formed on an insulating substrate 210 along the shape of a pixel area. A plurality of red, green and blue color filters 230R, 230G, 230B selectively filter only light having predetermined wavelengths. The red, green and blue color filters 230R, 230G, 230B may have various shapes, for example, a stripe type, or a mosaic type, according to their arrangement type. For example, when a plurality of red, green and blue color filters 230R, 230G, 230B are formed on black matrix 220 and substrate 210 and extend substantially along the columns of the pixel areas and periodically bend as the shape of the pixel areas bends. In other words, color filters 230R, 230G, 230B extend substantially in the longitudinal direction along pixel columns defined by black matrix 220 and are periodically bent along the shape of the pixel area. In the illustrative embodiment of the present invention, color filters 230R, 230G, 230B are formed on second display panel 2. However, the invention is not limited to the illustration and they may be formed on the first display panel 1.

A planarization layer 240 for planarizing step heights created by color filters 230R, 230G, 230B is formed on color filters 230R, 230G, 230B. The planarization layer 240 may be formed of an organic material.

A common electrode 250, opposite to and facing pixel electrode 80, is formed on planarization layer 240. The common electrode 250 is formed of a transparent conductive material such as amorphous or crystalline indium titanium oxide (ITO) or indium zinc oxide (IZO). Oblique cutouts 251a and 251c are formed on the common electrode 240 and are inclined substantially at 45 degrees or −45 degrees with respect to the gate line 22. Transverse cutout 251b is formed parallel with gate line 22. Cutouts 251a, 251b, and 251c serve as domain division means as mentioned above.

Organic layers (260a, 260b) are formed on common electrode 240. The organic layer 260a corresponds to a liquid crystal alignment guide unit having a tilt surface that pre-tilts liquid crystal molecules 5 while organic layer 260b corresponds to a cell gap maintaining unit positioned between first display panel 1 and second display panel 2 to maintain a cell gap between first display panel 1 and second display panel 2 constant.

Liquid crystal alignment guide unit 260a is inclined in opposite directions in view of the oblique cutouts 251a and 251c in the common electrode 240. In other words, liquid crystal alignment guide unit 260a is relatively thick at oblique cutouts 251a and 251c and gradually grows thinner away from the oblique cutouts. In other words, regions where the oblique cutouts 251a and 251c exist are disposed at protruding portions. Organic layers 260a and 260b may be formed of the same material as organic layer 90 formed on pixel electrode 80 of first display panel 1.

An alignment layer (not shown) that allows liquid crystal molecules 5 to be aligned in a predetermined direction may be disposed is formed on liquid crystal alignment guide unit 260a that pre-tilts liquid crystal molecules 5 at a predetermined angle. The alignment layer is formed conformally with liquid crystal alignment guide unit 260a and has a pre-tilt structure. The pre-tilt structure increases the response speed of liquid crystal molecules 5 as described above with regard to the alignment layer of pixel electrode 80. In a case where organic layers 260a and 260b have a capability of aligning liquid crystals in predetermined directions, the alignment layer is not necessary.

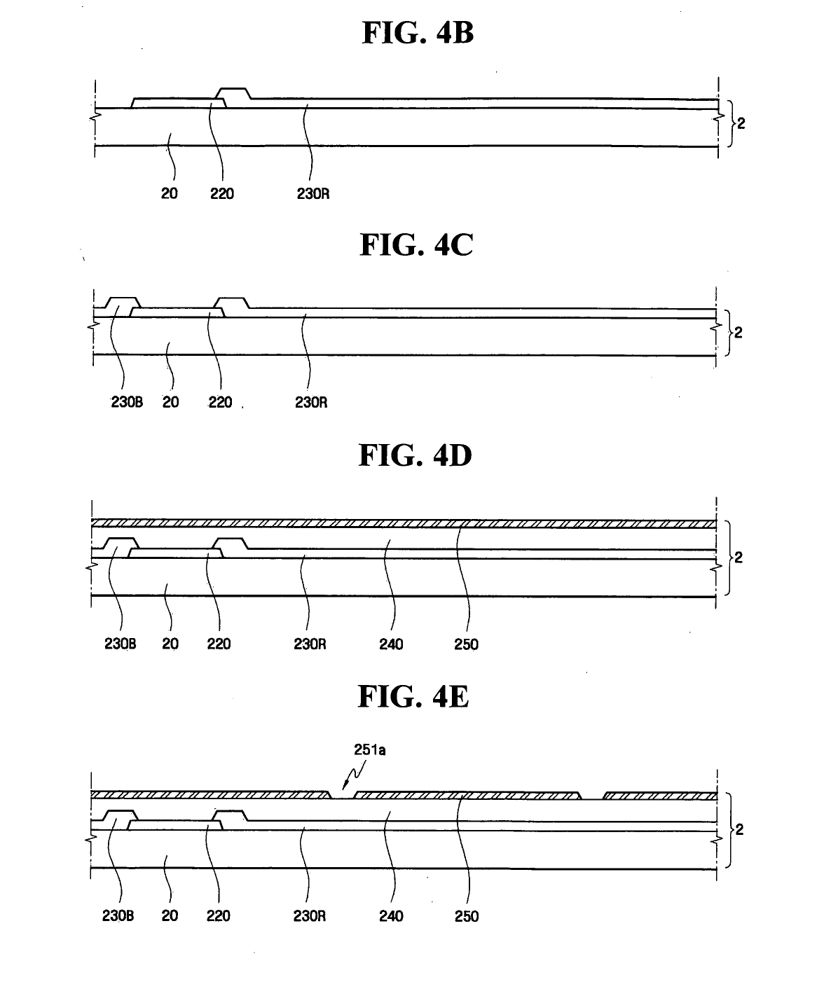

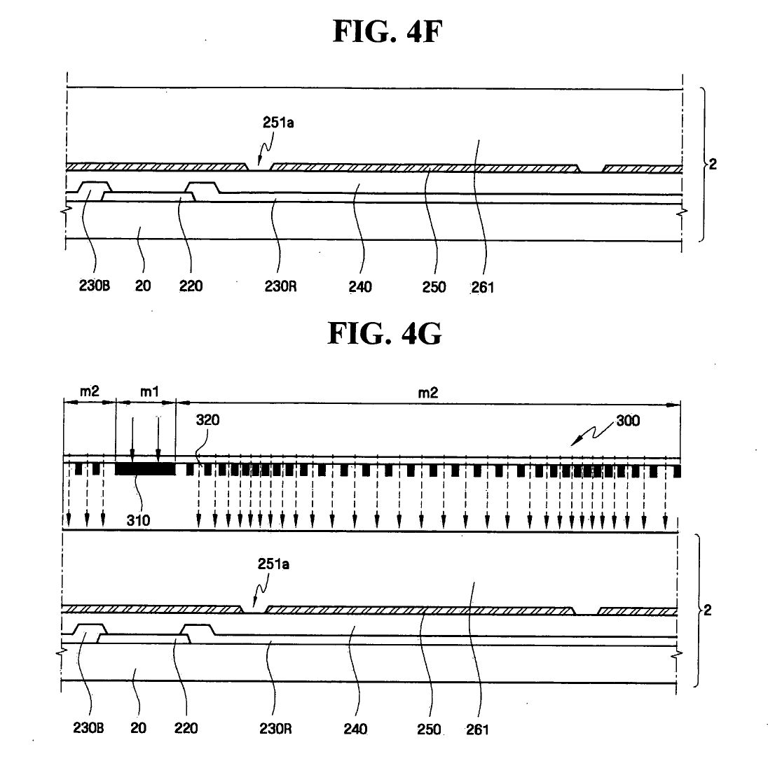

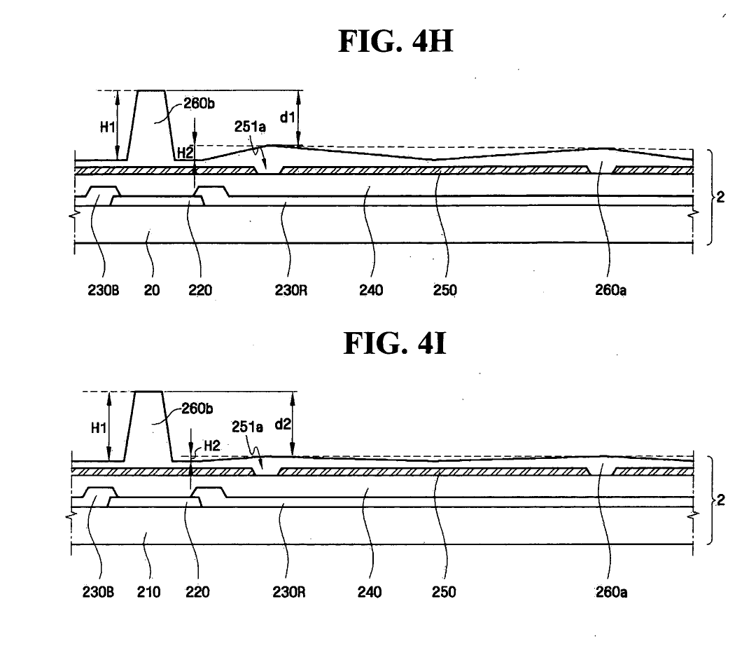

Cell gap maintaining unit 260b is formed in a region overlapping with the gate wire and/or the data wire of first display panel 1, e.g., between a region in which a thin film transistor (TFT) is formed and a region where black matrix 220 of second display panel 2 is formed. The cell gap maintaining unit 260b may be formed of the same material as liquid crystal alignment guide unit 260a during the formation of cell gap maintaining unit 260b. It is preferable that a predetermined top height difference d2 be formed between cell gap maintaining unit 260b and liquid crystal alignment guide unit 260a. For example, it is preferable that the predetermined top height difference d2 of not greater than 2 μm be formed between cell gap maintaining unit 260b and liquid crystal alignment guide unit 260a. A method of forming the predetermined top height difference d2 between cell gap maintaining unit 260b and liquid crystal alignment guide unit 260a will later be described with reference to FIGS. 4A through 41.

The first display panel 1 and the second display panel 2 are aligned to be assembled together with liquid crystal layer 3 injected therebetween, thereby completing the basic construction of the LCD 100, as shown in FIGS. 1C and 2. In other words, first display panel 1 and common electrode display panel 2 are aligned such that pixel electrode 80 perfectly overlaps with corresponding color filters 230R, 230G and 230B. As a result, a pixel is divided into a plurality of domains by cutouts 251a, 251b and 251c of common electrode 240 and pixel gap 83. In this case, oblique cutouts 251a and 251c and pixel gap 83 bisect the pixel into left and right halves parts. Meanwhile, the pixel is divided into four different domains because liquid crystals are aligned in different directions at upper and lower portions of a bent portion of the pixel. In other words, when an electric field is applied to liquid crystal layer 3, the pixel is divided into four different domains according to the alignment directions of the major directors of liquid crystal molecules 5 in liquid crystal layer 3. However, the present invention is not limited to the illustrated example, one pixel may also be divided into a plurality of domains by domain-division means formed on common electrode 240 and pixel electrode 80 and pixel gap 83.

LCD 100 is formed by the arrangement of various components, such as a pair of polarizers (not shown) and a backlight (not shown) in addition to the basic construction. At this time, each polarizer is aligned at either side of the basic construction, and its transmission axis is parallel with gate line 22 and the other is perpendicular to gate line 22.

With LCD 100 having the construction described above, when an electric field is applied to liquid crystals, liquid crystals in each domain may be aligned in a direction perpendicular to a longer side of the domain. Since the aligned direction is perpendicular to data line 62, that is, the same direction in which liquid crystals are laid down by a lateral field formed between adjacent pixel electrodes 80 with data line 62 disposed therebetween, thereby making the lateral field contribute to the alignment of liquid crystals in each domain.

Various inversion driving methods can be used such as such as dot inversion, column inversion, a two-dot inversion, etc., in which adjacent pixel electrodes are supplied with data voltages having opposite polarity with respect to a common voltage. Thus the lateral field between the adjacent pixel electrodes is generated to enhance the stability of each domain.

Since the transmission axes of the polarizers are arranged perpendicular to or parallel with gate line 22, the 45-degree intersection of the tilt directions and the transmission axes of the polarizers can give maximum transmittance in all domains while reducing the production costs.

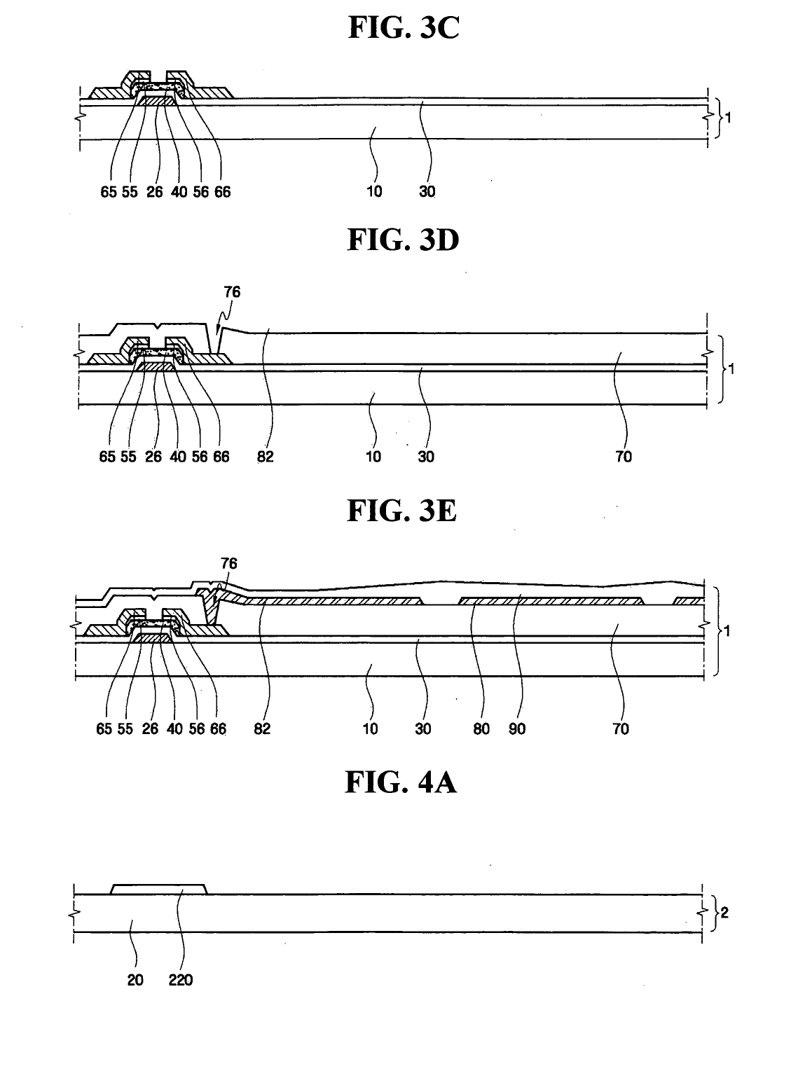

Next, a method of manufacturing the first display panel 1 of LCD 100 will be described in greater detail with reference to FIGS. 3A through 3E. FIGS. 3A through 3E are sectional views taken along a line II-II′ of FIG. 1A.

A conductive material such as aluminum, copper, silver or an alloy thereof is deposited on insulating substrate 10 and is patterned, thereby forming the gate wire including gate electrode 26, as shown in FIG. 3A. When necessary, the gate wire may have multi-layered structures having at least two layers.

Next, silicon nitride is deposited on the entire surface of insulating substrate 10 where the gate wire is formed, thereby forming gate insulating layer 30. Hydrogenated amorphous silicon (abbreviated as “a-Si”) and n+hydrogenated a-Si doped with high-concentration n-type impurity are sequentially deposited on gate insulating layer 30 and are patterned, thereby semiconductor layer 40 constituting a channel portion of a TFT and an n+hydrogenated a-Si layer 50 on semiconductor layer 40, as shown in FIG. 3B.

A conductive material such as aluminum, copper, silver, or an alloy thereof is deposited on the n+hydrogenated a-Si layer 50 and is patterned, thereby forming a data wire including a data line (not shown), source electrode 65 connected to the data line, and drain electrodes 66a and 66b spaced a predetermined distance apart from source electrode 65. By removing the n+ hydrogenated a-Si layer 50 between source electrode 65 and drain electrodes 66a and 66b, ohmic contact layers 55 and 56 are formed, as shown in FIG. 3C.

An organic material, a low-constant insulating material, or an inorganic material such as silicon nitride having a superior flatness characteristic and photosensitivity is deposited on ohmic contact layers 55 and 56 and is patterned, thereby forming passivation layer 70 having a plurality of contact holes as shown in FIG. 3D. Contact hole 76 exposing drain electrodes 66a and 66b is shown in FIG. 3D.

ITO or IZO is deposited on passivation layer 70 and is patterned, thereby forming pixel electrode 80. Then, organic layer 90 inclined in opposite directions is formed on pixel electrode 80 using a slit mask (not shown). Here, organic layer 90 is relatively thick at a portion of pixel gap 83 and gradually decreases toward the center of pixel electrode 80 from pixel gap 83. In other words, a region corresponding to pixel gap 83 becomes an organic layer ridge that is relatively high. At this time, it is preferable that the organic layer ridge has an angle larger than a critical value to prevent an afterimage from being generated. In such a manner, first display panel 1 of LCD 100 according to an embodiment of the present invention is completed.

Next, a method of manufacturing second display panel 2 according to an embodiment of the present invention will be described in greater detail with reference to FIGS. 4A through 41. FIGS. 4A through 41 are sectional views taken along a line II-II′ of FIG. 1C for showing a process of manufacturing a second display panel according to an embodiment of the present invention.

First, a layer made of an opaque material such as chromium is formed on a second insulating substrate 20 and is patterned, thereby forming black matrix 220, as shown in FIG. 4A. Black matrix 220 may be made of a metal such as chromium, and an inorganic or organic material.

Red photoresist is coated on the entire surface of second insulating substrate 20 and is exposed and developed, thereby forming red color filter 230R, as shown in FIG. 4B.

Although not shown in figures, green photoresist is coated on the entire surface of second insulating substrate 20 and is exposed and developed, thereby forming a green color filter 230G. In addition, blue photoresist is coated on the entire surface of second insulating substrate 20 and is exposed and developed, thereby forming blue color filter 230B, as shown in FIG. 4C. Thus, red, green, blue color filters 230R, 230G and 230B are formed.

In the illustrated example, photeresist resin is used as materials forming red, green, blue color filters 230R, 230G and 230B, but a resist material without photosensitivity can also be used. In this instance, a color resin is coated on the entire surface of second insulating substrate 20, followed by performing photo etching process. The illustrated embodiment has shown that red, green and blue color filters are formed in that order. However, the invention is not limited to the illustrated example and the filters may be formed in any sequence.

A planarization layer 240 and a common electrode 250 are formed by sequentially depositing an organic material and ITO or IZO on the entire surface of second insulating substrate 20 where color filters 230R and 230B are formed, as shown in FIG. 4D. A cutout 251a is formed by patterning common electrode 250, as shown in FIG. 4E.

An organic composition is coated on common electrode 250, thereby forming an organic layer 261, as shown in FIG. 4F. Here, the organic composition is coated in a state in which it is dissolved in an organic solvent. A thickness of organic layer 261 is made to be substantially the same as a cell gap between first and second display panels 1 and 2. Next, organic layer 261 is soft-baked, thereby evaporating solvent remaining the organic composition.

A mask 300 having a first region m1 where a light blocking pattern 310 is formed and a second region m2 where slit patterns 320 are formed is formed on second display panel 2, as shown in FIG. 4G. When mask 300 is aligned, it is preferable that first region m1 of mask 300 be formed corresponding to black matrix 210 of second display panel 2. Exposure is performed using mask 300.

Next, the first region m1 of mask 300 is entirely covered to form cell gap maintaining unit 260b and slit patterns 320 having different resolutions are formed in the second region m2 of mask 300. In more detail, the closer to cutout 251a of common electrode 250, the narrower the slit patterns 320. This enables a small amount of light to be transmitted through slit patterns 320. Conversely, the farther from cutout 251a of common electrode 250, the wider slit patterns 320. This enables a large amount of light to be transmitted through slit patterns 320.

Organic layers 260a and 260b are formed by developing exposed organic layer 261 using a water-soluble alkali developing solution using mask 300. As described above, organic layers 260a and 260b correspond to the liquid crystal alignment guide unit inclined in opposite directions with respect to cutout 251a of common electrode 250 and a cell gap maintaining unit 260b, as shown in FIG. 4H.

More specifically, since a region corresponding to light blocking pattern 310 of the first region m1 is not exposed, most of organic layer 261 remains. By contrast, second region m2 is a region where incident light incident is diffracted through slit patterns 320. Accordingly, the intensity of light incident to insulating substrate 20 is attenuated. Since a slit pattern tends to be exposed more at its wide portion than its narrow portion, organic layer 261 is almost completely removed during development, remaining only a small thickness, for example, 100-1000 Å. As a result, as stated above, organic layers 260a and 260b are formed, that is, cell gap maintaining unit 260b and liquid crystal alignment guide unit 260a inclined in opposite directions.

Although slit patterns 320 are formed in second region m2 of mask 300 to leave a portion of organic layer 261 behind in the illustrative embodiment of the present invention, but a half-tone mask (not shown) where a semi-transparent layer is formed may be used in second region m2. Upon the formation of organic layers 260a and 260b including cell gap maintaining unit 260b and liquid crystal alignment guide unit 260a through the process, a heat treatment is performed on second display panel 2 for a predetermined amount of time at a temperature higher than glass transition temperature (Tg) of organic layers 260a and 260b. For example, a heat treatment is performed on second display panel 2 at a temperature of about 180-230° C. for 30 minutes-1 hour. At this time, the heat treatment is performed for a smaller amount of time as the temperature increases.

If the heat treatment is performed under the above-described conditions, liquid crystal alignment guide unit 260a reflows and the top height of liquid crystal alignment guide unit 260a is lowered. As a result, as shown in FIG. 41, a predetermined top height difference d2, e.g., not less than 2 μm, is produced between the top height H1 of the cell gap maintaining unit 260b and the top height H2 of liquid crystal alignment guide unit 260a.

Referring to Table 1, a change in the top height H2 of liquid crystal alignment guide unit 260a depending on a temperature change will be described. Table 1 shows measured values of top height H1 of cell gap maintaining unit 260b and top height H2 of liquid crystal alignment guide unit 260a measured before and after heat treatment in each Example, and a height difference d1 before heat treatment and a height difference d2 after heat treatment calculated before and after heat treatment in each Example, respectively, between cell gap maintaining unit 260b and liquid crystal alignment guide unit 260a.

TABLE 1

| | | Unit (μm) | | |
|---|---|---|---|---|
| | | | Top Height | |
| | | | of liquid | |
| | | | crystal | |
| | | Height of cell | alignment | |
| | | gap maintaining | guide unit | |
| | | unit (H1) | (H2) | H1 − H2 |
| Experiment | Before heat | 5.21 | 4.7 | 0.51 |
| Example 1 | treatment | | | |
| | After heat | 5.86 | 2.46 | 3.4 |
| | treatment | | | |
| Experiment | Before heat | 5.21 | 4.55 | 0.66 |
| Example 2 | treatment | | | |
| | After heat | 5.88 | 2.75 | 3.13 |
| | treatment | | | |
| Experiment | Before heat | 5.21 | 4.69 | 0.52 |
| Example 3 | treatment | | | |
| | After heat | 5.57 | 3.15 | 2.42 |
| | treatment | | | |

(d1: Height difference before heat treatment, d2: Height difference after heat treatment)

As evident from Table 1, in Experiment Examples, 1, 2 and 3, the heat treatment was performed at temperatures of about 230° C., 200° C., and 180° C., respectively. Referring to Table 1, when the heat treatment was performed on second display panel 2 at a temperature of about 180-230° C., top height H2 of liquid crystal alignment guide unit 260a was reduced to half (½) when compared to that H1 before heat treatment. As a result, height difference d2, i.e., 2 μm or greater, was created between cell gap maintaining unit 260b and liquid crystal alignment guide unit 260a. In other words, a space for interposing the liquid crystal layer 3 between first display panel 1 and second display panel 2 can be obtained. Through such a process, second display panel 2 is completed. In addition, cell gap maintaining unit 260b and liquid crystal alignment guide unit 260a are simultaneously formed, thereby simplifying a manufacturing process.

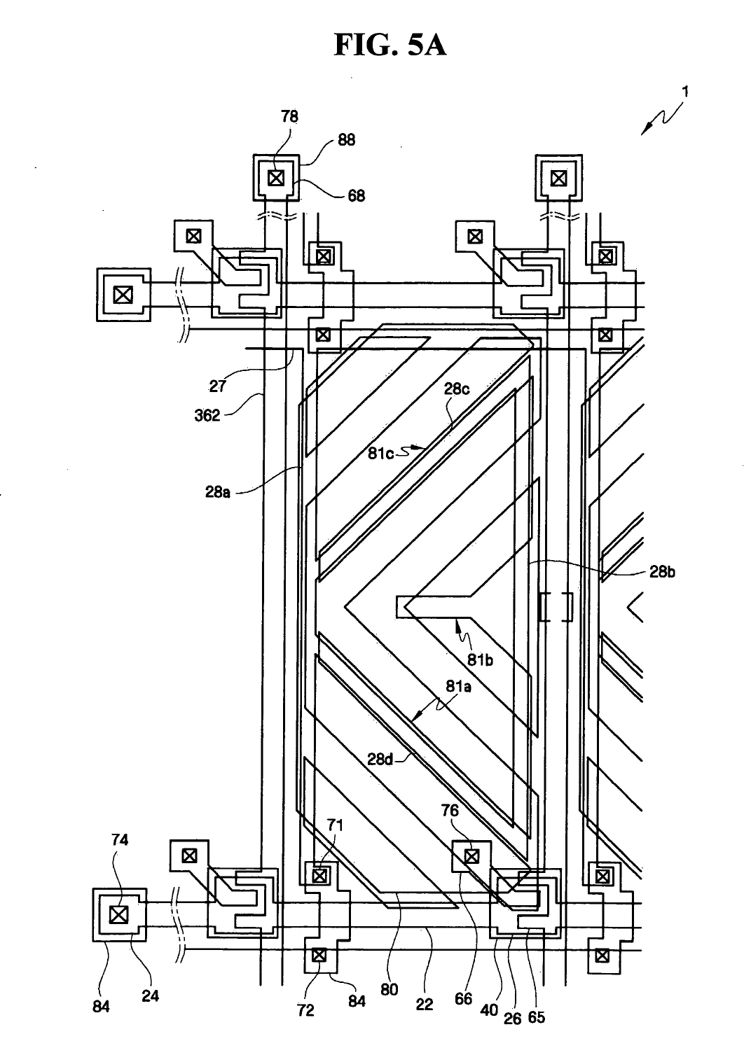

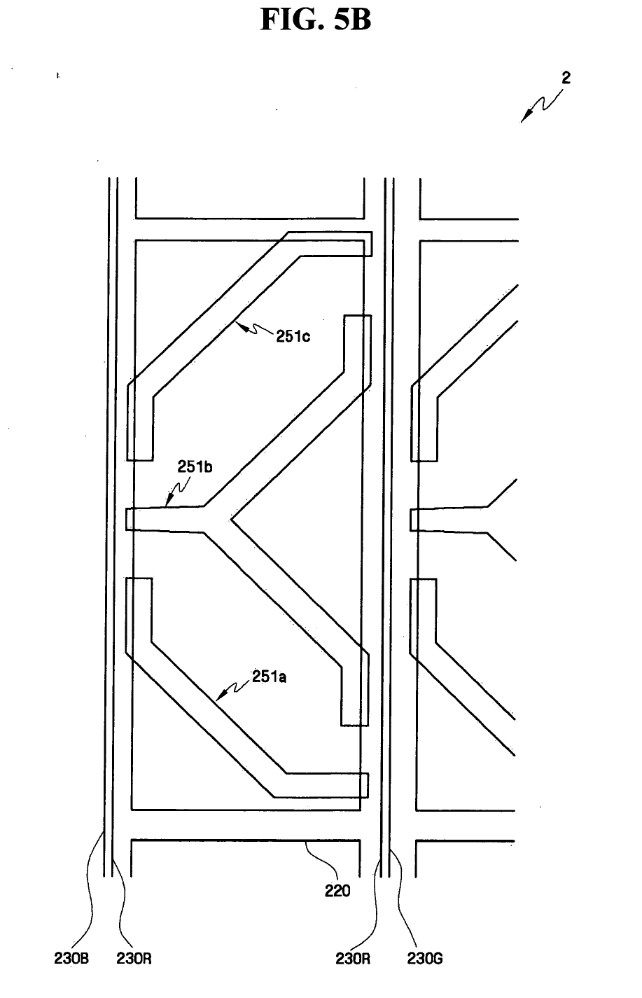

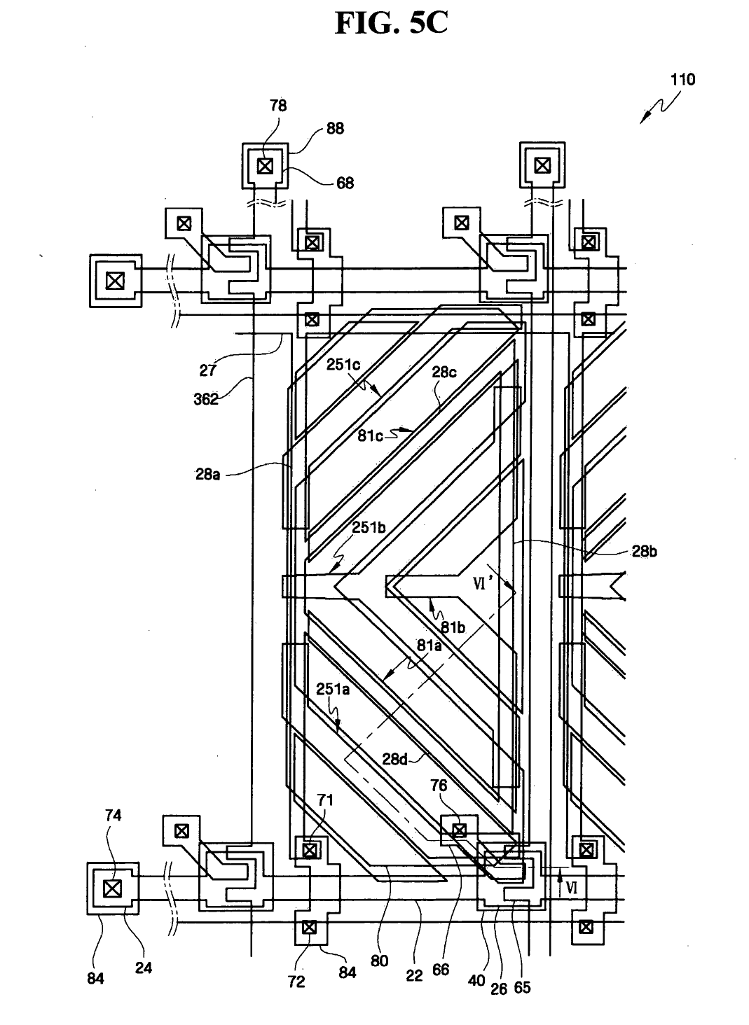

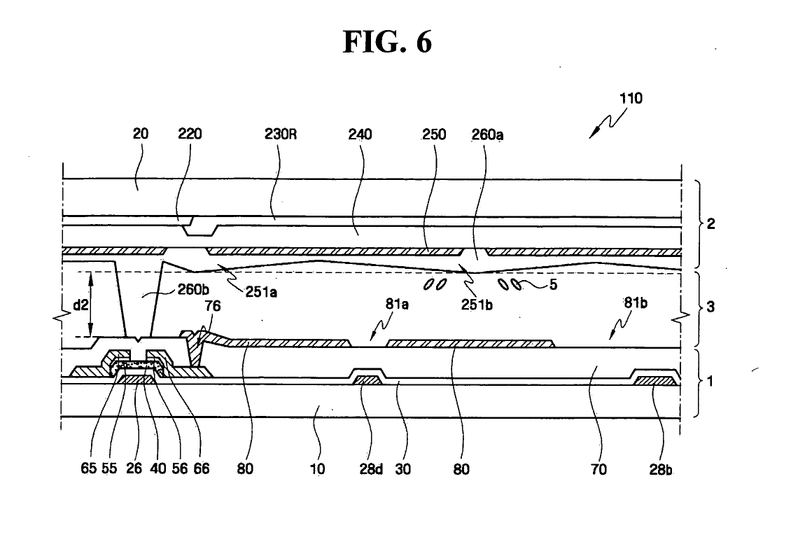

Next, an LCD 110 according to another embodiment of the present invention will be described with reference to FIGS. 5A through 6. FIG. 5A is a layout view of a first display panel 1 in an LCD according to another embodiment of the present invention, FIG. 5B is a layout view of a second display panel in the LCD according to another embodiment of the present invention, FIG. 5C is a layout view of the LCD including the first display panel of FIG. 5A and the second display panel of FIG. 5B, and FIG. 6 is a sectional view taken along a line VI-VI′ of FIG. 5C. For convenient explanation, the same reference numerals denote the same elements in the drawings for describing the previous embodiment, and thus any further descriptions of the same elements will be omitted.

As shown in FIGS. 5A through 6, the LCD 110 according to the illustrative embodiment of the present invention basically has the same structure as the LCD 100 except for the followings.

First, with respect to first display panel 1, a storage electrode line 27 is formed in parallel with a gate line 22 and storage electrodes 28a, 28b, 28c, and 28d are connected to storage electrode line 27 parallel with gate line 22 in an edge of a pixel region. Each of storage electrodes 28a, 28b, 28c, and 28d includes longitudinal portions 28a and 28b interconnected to storage electrode line 27 and oblique portions 28c and 28d overlapping cutouts 81a, 81b, and 81c of a pixel electrode 80 and connecting longitudinal portions 28a and 28b.

A data line 362 has only longitudinal portions without a bent portion. Thus, a pixel defined by an intersection of data line 362 and gate line 22 is shaped of a square. In this case, the length of data line 362 is reduced compared to that of data line 62 of the previous embodiment of the present invention, thereby reducing the resistance and load of a data wire, and ultimately lowering signal distortion. In addition, vertical stripe patterns resulting from coupling between data line 362 and pixel electrode 80 can be avoided.

A connection member 85 connecting storage electrode 28a and storage electrode line 27 vertically adjacent through contact holes 71 and 72 is formed on a passivation layer 70.

A pixel electrode 80 electrically connected to drain electrode 66 via contact hole 76 and positioned in a pixel is formed on passivation layer 70. In pixel electrode 80 are formed cutouts (81a, 81b, 81c) controlling the movement direction of liquid crystal molecules 5 by inducing distortion of an electric field. Cutouts (81a, 81b, 81c) are shaped such that they extend in the left direction from a bisecting location at which pixel electrode 80 is bisected into upper and lower halves. Each of cutouts (81a, 81b, 81c) includes a horizontal cutout 81b whose entrance is expanded symmetrically and oblique cutouts 81a and 81c formed obliquely in upper and lower portions of pixel electrode 80 halved by horizontal cutout 81b. Oblique cutouts 81a and 81c are formed to be perpendicular to each other in order to distribute a fringe field evenly in four directions. In this way, cutouts 81a, 81b and 81c of pixel electrode 80, together with cutouts of common electrode panel, serve as domain division means that dividing and aligning liquid crystal molecules 5.

Next, with respect to a second display panel 2, in common electrode 250 are formed cutouts (251a, 251b, 251c) controlling the movement direction of the liquid crystal molecules 5 by inducing distortion of an electric field, together with cutouts 81a, 81b and 81c of pixel electrode 80. Cutouts (251a, 251b, 251c) include oblique cutouts alternating and parallel with oblique cutouts 81 and 81c of pixel electrode 80 and a central cutout 251b formed at a bisecting common electrode 250 into upper and lower halves. Central cutout 81b bisects common electrode 250 from the left side and extends in a longitudinal direction in parallel with oblique cutouts 251a and 251b.

Organic layers (260a, 260b), which include a liquid crystal alignment guide unit 260a and a cell gap maintaining unit 260b, are formed on common electrode 250. Liquid crystal alignment guide unit 260a has a structure inclined in opposite directions with respect to cutouts 251a, 251b, and 251c. In other words, liquid crystal alignment guide unit 260a is relatively thick at portions of cutouts 251a, 251b, and 251c and gradually thinner as it gets away from portions of cutouts 251a, 251b, and 251c. Cell gap maintaining unit 260b and the liquid crystal alignment guide unit 260a are simultaneously formed on second display panel 2.

In addition, although not shown, an alignment layer for aligning liquid crystal molecules 5 is formed on organic layers 260a and 260b. The alignment layer covers organic layers 260a and 260b and is conformal to organic layers 260a and 260b so that it is pre-tilted. The pre-tilted structure increases a response speed of the liquid crystal molecules 5.

A method of manufacturing an LCD according to another embodiment of the present invention is the same as the method of manufacturing the LCD according to the embodiment of the present invention. However, unlike the embodiment of the present invention, when the first display panel 1 is manufactured, a process of forming an organic layer on the pixel electrode 80 for applying a pre-tilt to liquid crystal molecules 5 is skipped.

While organic layers (90, 260a) according to the illustrative embodiments of the present invention and the fabrication methods thereof that have been described above are formed on first display panel 1 and second display panel or second display panel 2 only, the invention is not limited thereto and they can also be formed on first display panel 1 only. In addition, while cell gap maintaining unit 260b and liquid crystal alignment guide unit 260a according to the illustrative embodiments of the present invention and the fabrication methods thereof that have been described above are simultaneously formed, the invention is not limited thereto and they may be simultaneously formed on first display panel 1.

In addition, according to the illustrative embodiments of the present invention and the fabrication methods thereof, it has been described that organic layers (90, 260a, 260b) are pre-tilted, they may have another structure or shapes. Rather, the invention is not limited to the illustrated example and can also be applied to any structure as long as organic layers (90, 260a, 260b) are formed between pixel electrode 80 and an alignment layer or between common electrode 250 and an alignment layer. Likewise, the invention can be applied even when there is no cutout in pixel electrode 80 and/or common electrode 250.

Further, the aforementioned embodiments can be applied to transmissive LCDs, semi-transmissive LCDs, and reflective LCDs. In addition, although it has been described that black matrixes and or color filters are formed on a second display panel, the invention is not limited thereto and they may be formed on a first display panel.

As described above, according to the present invention, a height difference of not less than 2 μm is created between a liquid crystal layer and a cell gap maintaining unit by simultaneously the liquid crystal alignment guide unit and the cell gap maintaining unit pre-tilting liquid crystals in a liquid crystal layer, thereby obtaining a sufficient space for interposing the liquid crystal layer between a first display panel and a second display panel.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A liquid crystal display (LCD) comprising:
a first display panel including a first field-generating electrode formed on a first insulating substrate;
a second display panel opposite to the first display panel and including a second field-generating electrode formed on a second insulating substrate;
a liquid crystal layer formed between the first display panel and the second display panel; and
organic layers formed on the second field-generating electrode and including a cell gap maintaining unit positioned between the first display panel and the second display panel, and a liquid crystal alignment guide unit having a tilt surface that pre-tilts the liquid crystal layer, the liquid crystal alignment guide unit and the cell gap maintaining unit having a top height difference of not less than 2 μm.

2. The LCD of claim 1, wherein the second display panel is a common electrode display panel and the second field-generating electrode is a common electrode.

3. The LCD of claim 1, wherein the second display panel is a thin film transistor (TFT) display panel and the second field-generating electrode is a pixel electrode formed for each pixel.

4. The LCD of claim 1, wherein the liquid crystal alignment guide unit is inclined in opposite directions with respect to a cutout formed in the second field-generating electrode.

5. The LCD of claim 4, wherein the liquid crystal alignment guide is thinner toward a portion away from the cutout.

6. The LCD of claim 1, further comprising an alignment layer that aligns the liquid crystal layer on the organic layers.

7. A method of manufacturing a liquid crystal display (LCD), the method comprising:
forming a first display panel including a first field-generating electrode on a first insulating substrate;
forming a second field-generating electrode on a second insulating substrate;
forming organic layers including a cell gap maintaining unit positioned between the first display panel and the second display panel to allow the first display panel and the second display panel to maintain a predetermined gap therebetween and a liquid crystal alignment guide unit having a tilt surface that pre-tilts the liquid crystal layer and having a top height difference of not less than 2 μm created between the liquid crystal alignment guide unit and the cell gap maintaining unit on the second field-generating electrode; and
interposing the liquid crystal layer between the first display panel and the second display panel where the organic layers are formed.

8. The method of claim 7, wherein the forming of the organic layers comprises:
coating an organic composition on the second field-generating electrode;
exposing the second insulating substrate using a mask having a first region and a second region and developing the exposed second insulating substrate; and
performing a heat treatment on the second insulating substrate.

9. The method of claim 8, wherein the heat treatment is performed on the second insulating substrate at a temperature of about 180-230° C. for 30 minutes-1 hour.

10. The method of claim 7, further comprising forming an alignment layer for aligning the liquid crystal layer on the organic layers after the formation of the organic layers.

11. The method of claim 7, wherein the second display panel is a common electrode display panel and the second field-generating electrode is a common electrode.

12. The method of claim 7, wherein the second display panel is a thin film transistor (TFT) display panel and the second field-generating electrode is a pixel electrode formed for each pixel.
